(19) United States
(12) Patent Application Publication
(10) Pub. No.: US 2009/0115738 A1
(43) Pub. Date: May 7, 2009

(54) Display with touch panel

(75) Inventor: Chien-Tsai Chueh, Hsinchu (TW)

Correspondence Address: BACON & THOMAS, PLLC, 625 SLATERS LANE, FOURTH FLOOR, ALEXANDRIA, VA, 22314-1176, US

(73) Assignee: Coretronic Corporation, Hsinchu (TW)

(21) Appl. No.: 12/213,044

(22) Filed: Jun. 13, 2008

(30) Foreign Application Priority Data
Nov. 7, 2007 (TW) 096141968

(51) Int. Cl. G06F 3/041

(52) U.S. Cl. 345/173

(57) ABSTRACT

A flat panel display having a display panel, a touch panel, a supporting structure and a frame is provided. The touch panel is assembled on the display panel. The supporting structure has a supporting unit and an elastic unit at least. The supporting unit is utilized for carrying the touch panel. The elastic unit has a fixed end and an extending end. The extending end is connected to the supporting unit. The elastic unit has a bending with a changeable bending angle varied with the impact force stressed to the supporting unit. The frame is assembled on the touch panel to restrict vertical movement of the touch panel.

### BACKGROUND OF THE INVENTION

(1) Field of the Invention

The present invention relates to a flat panel display with a touch panel, and more particularly relates to a flat panel display capable of preventing the display panel thereof being damaged by the impact force stressed on the touch panel.

(2) Description of the Prior Art

In present, attending with the development of flat panel displaying technologies, flat panel displays have become a main stream product for the displaying industries. Meanwhile, many flat panel displays have integrated touch panels as an interface for users to input control signal by merely pressing the on-screen button.

The touch panel is operated by being touched by the user. However, impact forces stressed to the touch panel may drive the touch panel pressing the display panel to result in damage. In order to prevent the display panel from being damaged by the touch panel, proper supporting units are demanded to carry the touch panel.

FIG. 1 is a schematic cross-section view of a typical flat panel display 100 with a touch panel 140. As shown, the flat panel display 100 has a display panel 120, a touch panel 140, and a frame 160. The touch panel 140 is fixed between the display panel 120 and the frame 160. A separating layer 130 is interposed between the display panel 120 and the touch panel 140 to prevent the display panel 120 from being contacted to the touch panel 140. A buffer unit 131 is interposed between an upper surface of the touch panel 140 and the frame 160. The buffer unit 131, which is utilized for separating the touch panel 140 and the frame 160, can prevent the touch panel 140 from being directly pressed and scraped by the frame 160 to result in damage.

As indicated by the arrow in the figure, the impact force F downwardly stressed on the touch panel 140 may generate unwanted waving on the display panel 120 to influence the display on the screen. A huge impact force F may further break the touch panel 140 or damage the display panel 120 under the buffer layer 130.

The problem that the touch panel 140 is not strong enough to suffer the impact force can be promoted by increasing the thickness of the touch panel 140. However, even if the thickness of the touch panel 140 is increased, the problem that the display panel 120 is pressed by the impact force F is still existed.

Therefore, it is still an important issue to find a way to relieve the pressing force stressed on display panel 120 from the touch panel 140 to prevent the display panel 120 from being damaged.

### SUMMARY OF THE INVENTION

It is an object of the present invention to relieve pressing force stressed on the display panel from an impact force stressed on the touch panel so as to prevent the display panel from being damaged.

According to an embodiment of the present invention, a flat panel display having a display panel, a touch panel, a supporting structure and a frame is provided. The touch panel is assembled on the display panel. The supporting structure has a supporting unit and an elastic unit at least. The supporting unit is utilized for carrying the touch panel. The elastic unit has a fixed end and an extending end. The extending end is connected to the supporting unit. The elastic unit has at least one bending with a changeable bending angle. The changeable bending angle is varied with an impact force stressed to the supporting unit. The frame is assembled on the touch panel to restrict the vertical movement of the touch panel.

In an embodiment of the present invention, the supporting unit has a horizontal portion and a vertical portion. The horizontal portion touches the lower surface of the touch panel. The vertical portion is connected between the horizontal portion and the elastic unit. A predetermined distance is kept between the vertical portion and an edge of the touch panel.

In an embodiment of the present invention, the supporting structure has a fixing unit. The fixed end of the elastic unit is fixed to the fixing unit. In addition, the fixing unit has at least two positioning pins for positioning the fixing unit on a sidewall of a back cover of the flat panel display.

In an embodiment of the present invention, the supporting structure has a side plate lining to the edge of the touch panel to restrict the horizontal movement of the touch panel.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The present invention will now be specified with reference to its preferred embodiment illustrated in the drawings, in which:

FIG. 1 is a schematic cross-section view of a typical flat panel display with a touch panel;

FIG. 2 is a schematic cross-section view of a flat panel display according the preferred embodiment of the present invention;

FIG. 3 is a schematic view of a fixing unit of the supporting structure according the preferred embodiment of the present invention.

FIG. 4 is a top view of the supporting structure of FIG. 2;

FIG. 5 is a schematic cross-section view of a supporting structure according another preferred embodiment of the present invention; and

FIG. 6 is a schematic cross-section view of a flat panel according another preferred embodiment of the present invention.

### DESCRIPTION OF THE PREFERRED EMBODIMENT

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

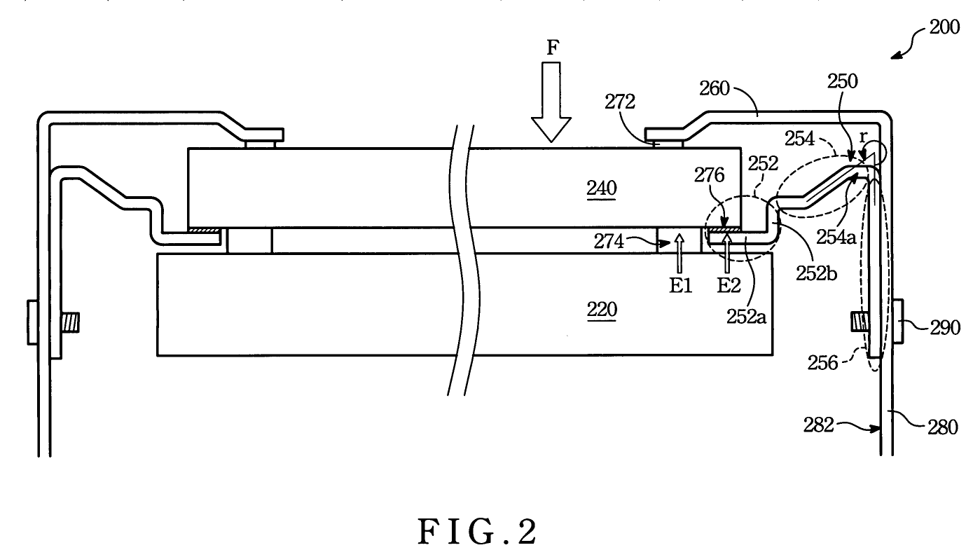

FIG. 2 is a schematic cross-section view of the flat panel display 200 according a preferred embodiment of the present invention. As shown, the flat panel display 200 has a display panel 220, a touch panel 240, a supporting structure 250, and a frame 260. The touch panel 240 is assembled on the display panel 220. The frame 260 is assembled on the touch panel 240 and presses an upper surface of the touch panel 240 to restrict vertical movement thereof.

In order to prevent the touch panel 240 from being scraped by the frame 260 to result in damage, a first buffer unit 272 is interposed between the upper surface of the touch panel 240 and the frame 260. The first buffer unit 272 is also capable to relieve the pressing force stressed by the frame 260 to the touch panel 240.

In addition, a second buffer unit 274 is interposed between the display panel 220 and the lower surface of the touch panel 240 to prevent the touch panel 240 from directly pressing the display panel 220 to result in damage. As the impact force F is downwardly stressed on the touch panel 240, the second buffer unit 274 is compressed and a recovery force El is generated upwardly and stressed to the touch panel 240 to cancel part of the impact force F. Thus, the pressing force from the touch panel 240 to the display panel 220 is buffed by the second buffer unit 274. As a preferred embodiment, the first buffer unit 272 and the second buffer unit 274 may be sponge layers.

The supporting structure 250 has a supporting unit 252, an elastic unit 254, and a fixing unit 256. The supporting unit 252 is utilized for carrying the touch panel 240. The fixing unit 256 is utilized for fixing the supporting structure 252 to a sidewall 282 of a back cover 280 of the flat panel display 200. The elastic unit 254 has a fixed end and an extending end. The fixed end is fixed to the fixing unit 256, and the extending end is connected to the supporting unit 252. The recovery force generated by the elastic unit 254 can balance part of the impact force F so as to reduce the amount of compression of the second buffer unit 274 as well as the pressing force stressed to the display panel 220.

The supporting unit 252 has a horizontal portion 252a and a vertical portion 252b to form an L-shaped structure. The horizontal portion 252a is located below the touch panel 240. The vertical portion 252b is connected between the horizontal portion 252a and the elastic unit 254. A third buffer unit 276 is interposed between the horizontal portion 252a and the lower surface of the touch panel 240 to prevent the touch panel 240 from being damaged by the supporting unit 252. In addition, a predetermined distance is kept between the vertical portion 252b and an edge of the touch panel 240 so as to prevent the touch panel 240 from being touched by the vertical portion 252b as the supporting unit 252 is deformed by the impact force F.

The elastic unit 254 has a bending 254a with a predetermined bending angle r from the fixing unit 256. In the present embodiment, the bending angle r is about 135 degrees. It is noted that the bending angle r is changeable and would be varied by the impact force stressed to the supporting unit 252. In addition, the more the bending angle r is varied, the greater the recovery force E2 is generated by elastic unit 254 and stressed through the supporting unit 252 to the touch panel 240. Thus, as the impact force F is stressed to the touch panel 240, the elastic unit 254 is capable of generating the recovery force E2 to balance the impact force F and reduce the pressing force stressed to the display panel 220.

In order to provide sufficient the recovery force E2 under limited deformation, the supporting structure 250 had better be formed of metallic material. In contrast with second buffer unit 274, the supporting structure 250 is formed of high elasticity metallic material. Thus, even if a huge impact force F is stressed to the touch panel 240, the supporting structure 250 is capable to generate sufficient the recovery force E2 to balance the impact force F to prevent the display panel 220 from being damaged by the impact force F.

The fixing unit 256 in the present embodiment is fixed on a sidewall 282 of the back cover 280 by using screws 290. However, it should not be a limitation to the present invention. It is noted that the fixing unit 256 may be fixed on the sidewall of the frame 260. It is also noted that the fixing unit 256 may be fixed on the sidewall 282 of the back cover 280 by gluing or locking.

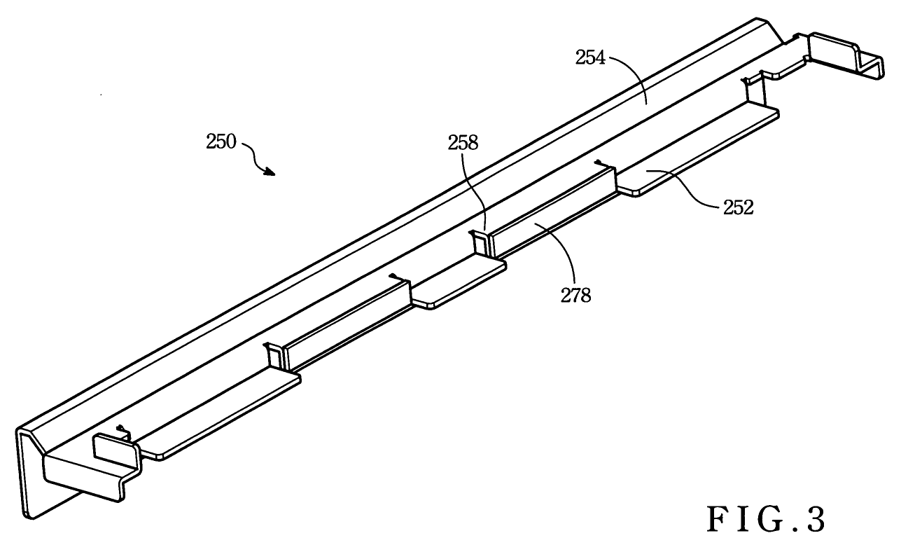

Referring to FIG. 3, the supporting structure 250 has a side plate 258 close to the elastic unit 254. The side plate 258 lines to an edge of the touch panel 240 to restrict horizontal movement of the touch panel 240. In addition, a fourth buffer unit 278 is interposed between the side plate 258 and the edge of the touch panel 240 to separate the side plate 258 and the touch panel 240 and prevent the touch panel 240 from being scraped and directly pressed by the side plate 258.

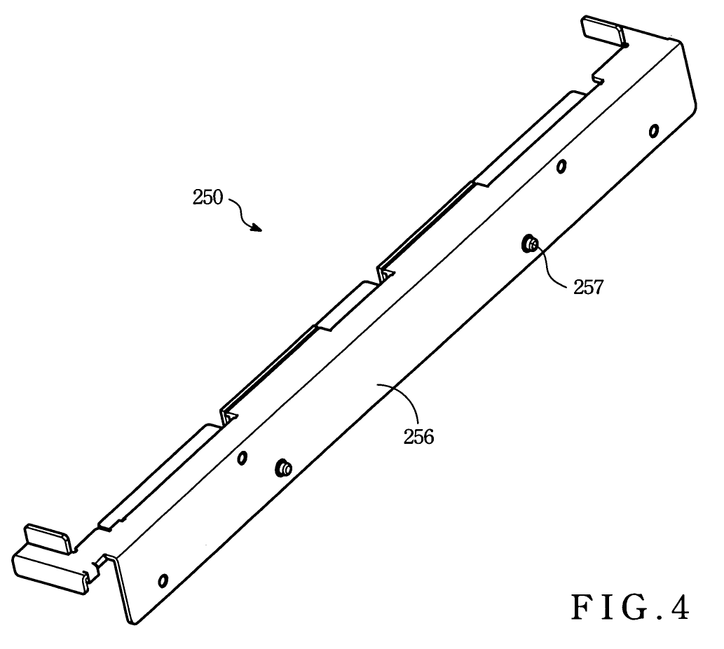

In addition, referring to FIG. 4, the fixing unit 256 has at least two positioning pins 257 extended from the back side thereof toward the sidewall 282 of the back cover 280. Two positioning pins 257 are shown in this figure. The positioning pins 257 can be assembled into corresponding holes (not shown) formed on the sidewall 282 of the back cover 280 for rapidly positioning the supporting structure 250 so as to facilitate following fixing process.

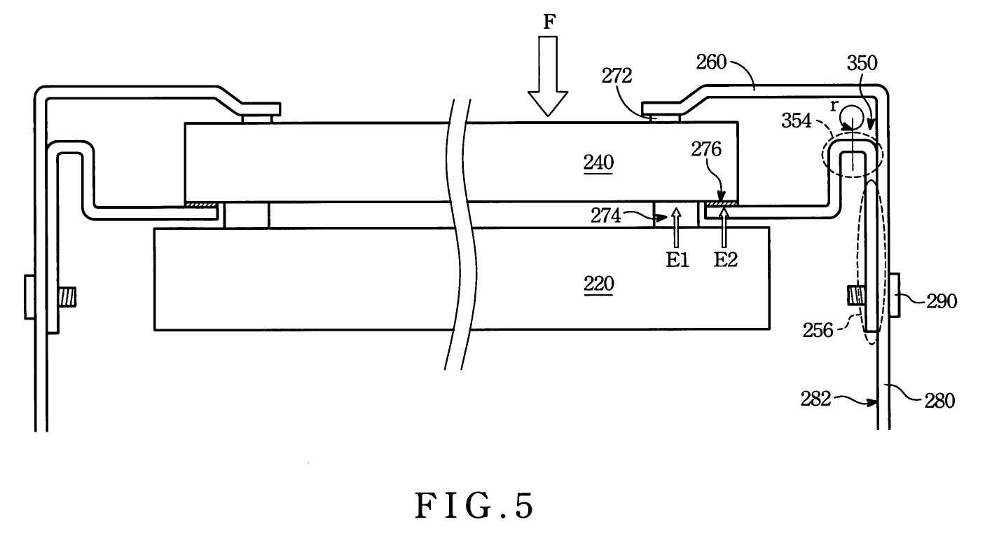

FIG. 5 is a schematic view of another preferred embodiment of the supporting structure 350 in the present invention. In contrast with the embodiment of FIG. 2, the present embodiment features an elastic unit 354 with a predetermined bending angle r of about 180 degrees from the fixing unit 256. The recovery force provided by the supporting structure 350 in the present embodiment is smaller because the deformation is limited. However, the distance between the edge of the touch panel 240 and the sidewall 282 of the back cover 280 can be reduced by using the present supporting structure 350 and the size of the flat panel display can be reduced.

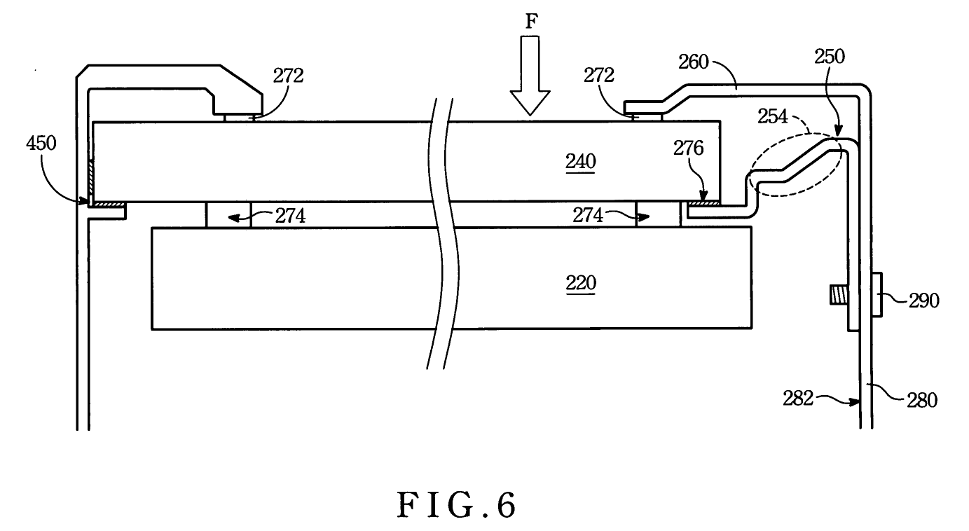

FIG. 6 is a schematic view of another preferred embodiment of the flat panel display in the present invention. In contrast with the embodiment of FIG. 2, which has the supporting structures 250 assembled on two opposite sides of the touch panel 240 for carrying the touch panel 240, the flat panel display of the present embodiment has just one supporting structure 250 with the elastic unit 254 assembled on one side of the touch panel 240. The other side of the touch panel 240 is carried by a simple L-shaped supporting unit 450. Although the L-shaped supporting unit 450 lacks the ability to suffer the impact force F stressed to the touch panel 240, it is helpful for reducing the size of the flat panel display.

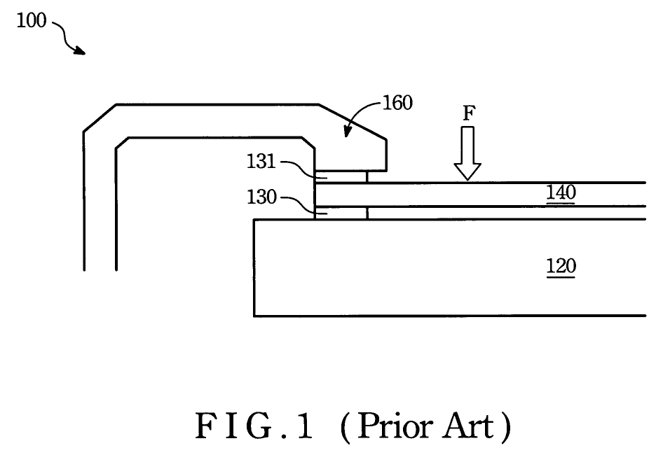

Referring to FIG. 1, the traditional flat panel display 100 only has the buffer layer 130 interposed between the touch panel 140 and the display panel 120 to prevent the display panel 120 from being damaged by the impact force F stressed to touch panel 140. Although the strength of the touch panel 140 may be enhanced by increasing the thickness thereof, the problem that the display panel 120 being damaged by the impact force F cannot be prevented. In contrast, referring to FIG. 2, in addition to the second buffer unit 274 interposed between the touch panel 240 and the display panel 220, the flat panel display 200 according to the embodiments of the present invention has a supporting structure 250 with good elastic recovering ability to carry the touch panel 240. The amount of compression of the second buffer unit 274 is thus reduced and the pressing force stressed to the display panel 220 can be relieved.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A flat panel display comprising:
a display panel;
a touch panel, assembled on the display panel;
a supporting structure, having:
a supporting unit, utilized for carrying the touch panel; and
an elastic unit, having a fixed end and an extending end connected to the supporting unit, and having at least a bending with a changeable bending angle varied with an impact force stressed to the supporting unit; and
a frame, assembled on the touch panel to restrict vertical movement of the touch panel.

2. The flat panel display of claim 1 further comprising a first buffer unit assembled between the frame and an upper surface of the touch panel.

3. The flat panel display of claim 1 further comprising a second buffer unit assembled between the display panel and a lower surface of the touch panel.

4. The flat panel display of claim 3, wherein the second buffer unit comprises a sponge layer.

5. The flat panel display of claim 1 further comprising a third buffer unit interposed between the supporting unit and a lower surface of the touch panel.

6. The flat panel display of claim 1, wherein the supporting unit has a horizontal portion and a vertical portion, the horizontal portion is located below the touch panel, the vertical portion is connected between the horizontal portion and the elastic unit, and a predetermined distance is kept between the vertical portion and an edge of the touch panel.

7. The flat panel display of claim 6, wherein the supporting structure further comprises a side plate lining to the edge of the touch panel for restricting horizontal movement of the touch panel.

8. The flat panel display of claim 7 further comprising a fourth buffer unit interposed between the side plate and the edge of the touch panel.

9. The flat panel display of claim 7, wherein the side plate is adjacent to the elastic unit.

10. The flat panel display of claim 1 further comprising a back cover, wherein the supporting structure is fixed on a sidewall of the back cover.

11. The flat panel display of claim 10, wherein the supporting structure further has a fixing unit with at least two positioning pins for positioning the fixing unit on the sidewall of the back cover, and the fixed end of the elastic unit is fixed to the fixing unit.

12. The flat panel display of claim 1, wherein the bending angle is about 135 degrees.

13. The flat panel display of claim 1, wherein the bending angle is about 180 degrees.
